(19) United States
(12) Patent Application Publication
(10) Pub. No.: US 2004/0250667 A1
(43) Pub. Date: Dec. 16, 2004

(54) Food bar cutter

(76) Inventor: Andrea E. Atwater, Barrington, IL (US)

Correspondence Address: MERONI + MERONI, P.O. BOX 309, BARRINGTON, IL, 60011, US

(21) Appl. No.: 10/459,821

(22) Filed: Jun. 11, 2003

(51) Int. Cl. B23D 7/00; B26D 1/00; B26B 29/00

(52) U.S. Cl. 83/13; 83/746; 83/697; 30/289; 30/303; 30/315

(57) ABSTRACT

A foldable cutter for sectioning an entire food item within a baking pan into smaller sections. The cutter has an orthogonally arranged lattice of cutting blades sized and shaped to fit within a baking pan having an upright side for sectioning an entire food item within the food preparation container into a plurality of smaller sections. A plurality of hinge connections hingedly connects the cutting blades providing means for pivotally changing the relationship between the cutting blades from the orthogonal arrangement to a substantially coplanar arrangement for storage. The end portions of the cutting blades are angled to compensate for angularity of the upright side of the baking pan during use. A removable handle is used for providing manual force perpendicular to the cutting blades during use.

### BACKGROUND OF THE INVENTION

1. Field of the Invention

The claimed invention generally relates to cutting devices. More specifically, the claimed invention relates to a device for cutting food into bars.

2. Description of the Prior Art

It is common practice to bake food items such as brownies, cakes, and cookies as one continuous sheet in baking pans of standard sizes such as 9 inches by 13 inches and 8 inches by 8 inches. The sheet is then commonly sliced into a plurality of smaller food items such as bars or squares for removal from the baking pan. The task of slicing the sheet into bars or squares is commonly performed by using a knife or other similar instrument having a single cutting blade that is customarily used to make several individual longitudinal and lateral sectioning cuts defining the sides of each of the bars or squares.

The task of slicing the sheet into a number of smaller bars or square with a single bladed knife requires overcoming several challenges in order to achieve a desirable end result. One of the challenges that must be overcome is ensuring that the sectioning cuts are made straight. Freehandedly cutting a straight line in a sheet of brownies using a single bladed knife without reference to a straight edge such as the upright side of the baking pan is often difficult to accomplish. Another challenge that must be overcome is ensuring that the sectioning cuts are made completely through the food item. If close attention is not paid to the depth of the cut made by the knife, the individual bars or squares will often not be completely separated. An even further challenge that must be overcome is ensuring that the bars or squares are sized appropriately. It is commonly desired to evenly section the food item so that all of the bars or squares are of the same size. However, it is difficult to achieve squares or bars of the same size when freehandedly cutting the sheet with a single blade knife.

There are several different types of cutting apparatus in the prior art that use multiple cutting blades to cut food items into smaller sections. Some of these prior art devices are disclosed here in the form of previously issued United States Patents. However, these previously issued United States Patents do not disclose or teach a device that addresses the previously mentioned problems concerning cutting a sheet of brownies or similar type food item into a plurality of smaller portions within a baking pan having upright sides.

U.S. Pat. No. 4,648,300 issued to Hassenfelt discloses a biscuit cutting apparatus having a square frame defining a dough compartment. A plurality of vertical slots in each side wall extend from the top edge thereof down to the cutting surface to provide a guide for a cutting blade inserted therein. The slots are arranged in such a pattern that three, four, or six equal width slices may be formed in each direction depending on the slots selected for use.

U.S. Pat. No. 5,343,623 issued to Cole discloses a knife blade and knife blade assembly for cutting food products into sticks or slices without causing surface cracking. FIG. 6 shows an array of knife blades arranged to form a rectangular pattern.

U.S. Pat. No. 5,579,582 issued to Carlson discloses a puzzle cookie cutter having a cutting die holder and at least one cutting die removably securable in the holder. The die or dies provide for the cutting of cookie dough, batter, or the like into several separate, irregularly shaped and sized interfitting pieces, which pieces may be reassembled as a puzzle after baking to provide entertainment for the consumer of the cookie. The dies may be provided is virtually any regular or irregular geometric shape, animal or other caricature or representation, and/or any alphanumeric character, as desired.

These previously issued United States Patents do not disclose or teach a cutting device that is used to cut a food item sheet within a standard sized baking pan having upright sides into a plurality of uniformly sized and shaped smaller portions. Therefore, there is a need for a device that can uniformly and simultaneously section a food item sheet within a baking pan having upright sides into smaller portions. There is a further need for a device of this type that is easily stored during periods of time when the device is not in use. Therefore, there is a need for a food bar cutter that is collapsible into a folded form for ease of storage.

### SUMMARY OF THE INVENTION

To provide an answer for these needs, as well as other that will become apparent after reading this specification and viewing the appended drawings, the claimed invention provides a food bar cutter that cuts a plurality of smaller food portions from a food item sheet within a baking pan having upright sides.

It is an object of the claimed invention to provide a food bar cutter capable of making straight sectioning cuts.

It is a further object of the claimed invention to provide a food bar cutter capable of making sectioning cuts of uniform depth.

It is an even further object of the claimed invention to provide a food bar cutter capable of sectioning an entire food item within a baking pan into a plurality of uniformly shaped smaller sections.

It is still a further object of the claimed invention to provide a food bar cutter having a plurality of opposingly oriented blades that are collapsible into a compact configuration for storage.

The food bar cutter generally comprising an orthogonally arranged lattice of cutting blades, a plurality of hinge connections, and a pair of handles.

The orthogonally arranged lattice of cutting blades are sized and shaped to fit within a food preparation container, such as a 9 inch by 12 inch baking pan having upright sides. The cutting blades are made to section an entire food item within the baking pan into a plurality of smaller sections or bars. The cutting blades have end portion angled to compensate for angularity of the upright outer side walls of the baking pan. The food bar cutter may also have edge blades connected to the ends of the lateral cutting blades and longitudinal cutting blades for cutting off the edge of the brownie sheet about the margin of the food item.

The plurality of hinge connections hingedly connects the cutting blades at their intersections to provide means for pivotally changing the relationship between the cutting blades from the orthogonal arrangement to a substantially coplanar arrangement. The folded coplanar arrangement of the brownie bar cutter allows for easy storage while not in use.

The pair of handles allows a user to provide manual force perpendicular to the cutting edge of the cutting blades during use. The handles may be removable or permanently fixed to he cutting blades.

### BRIEF DESCRIPTION OF THE DRAWINGS

FIG. 1. FIG. 1 shows a perspective view of the food bar cutter.

FIG. 2. FIG. 2 shows a perspective view of the food bar cutter with end blades.

FIG. 3. FIG. 3 shows a perspective view of the food bar cutter in a folded orientation.

FIG. 4. FIG. 4 shows a perspective view of the food bar cutter positioned over a pan containing a food item.

FIG. 5. FIG. 5 shows a perspective view of the food bar cutter with end blades positioned over a pan containing a food item.

FIG. 6. FIG. 6 shows a perspective view of the food bar cutter sectioning the food item into a plurality of smaller sections.

FIG. 7. FIG. 7 shows a top view of a food item sheet sectioned into a plurality of smaller section within a pan where the margin of the food item has been sectioned from the food item sheet.

FIG. 8. FIG. 8 shows another embodiment of the invention.

FIG. 8a. FIG. 8a shows an enlarged view of the hinge detail.

FIG. 9. FIG. 9 shows the cutter of FIG. 8 in a folded configuration.

### DETAILED DESCRIPTION OF THE PREFERRED EMBODIMENT

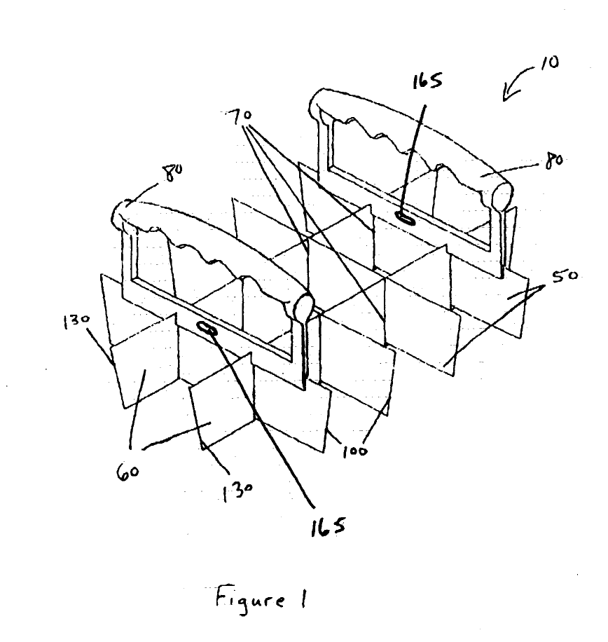

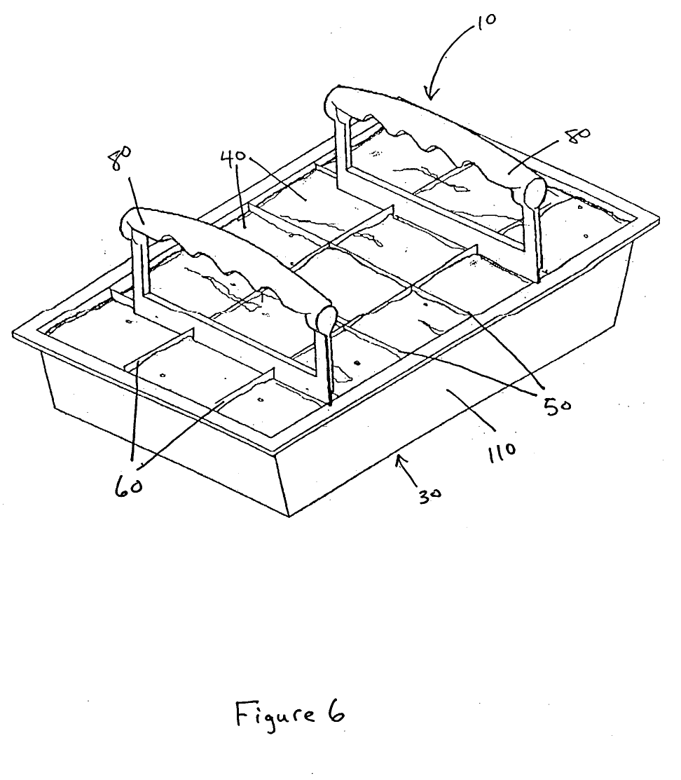

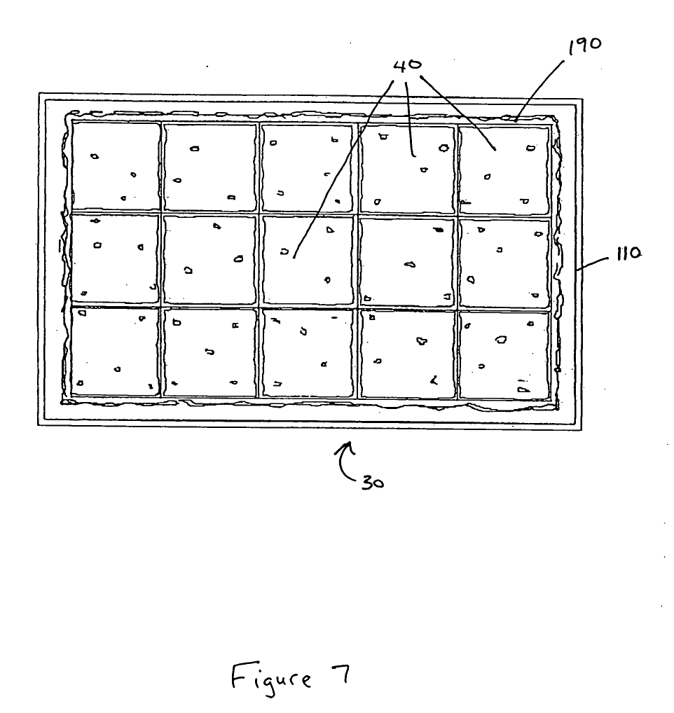

Turning to the drawings, FIG. 1 shows a preferred embodiment of the foldable food bar cutter 10 of the claimed invention for sectioning an entire food item 20, such as brownies, cakes, or cookies within a food preparation container or baking pan 30 into a plurality of equally sized smaller sections 40 as illustrated in FIGS. 6 and 7. However, it is contemplated as being within the scope of the claimed invention that the food bar cutter may be configured and used to cut or section other food items such as pizza. Accordingly, the embodiments shown throughout the drawings are preferred embodiments and should not limit the breadth of interpretation afforded to the patent claims accompanying this specification. The food bar cutter 10 generally comprises a plurality of lateral cutting blades 50, a plurality of longitudinal cutting blades 60, a plurality of hinges 70 connecting the lateral and longitudinal blades, and a pair of handles 80.

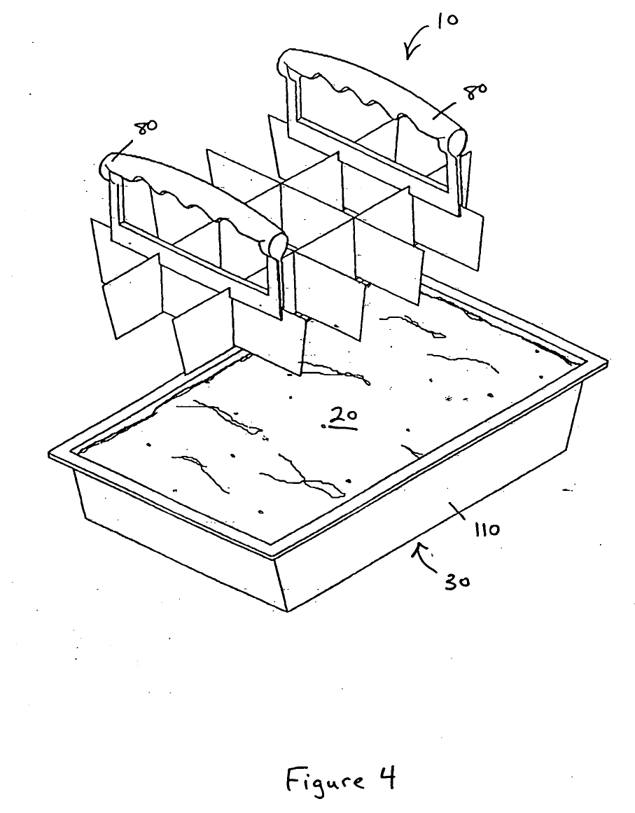

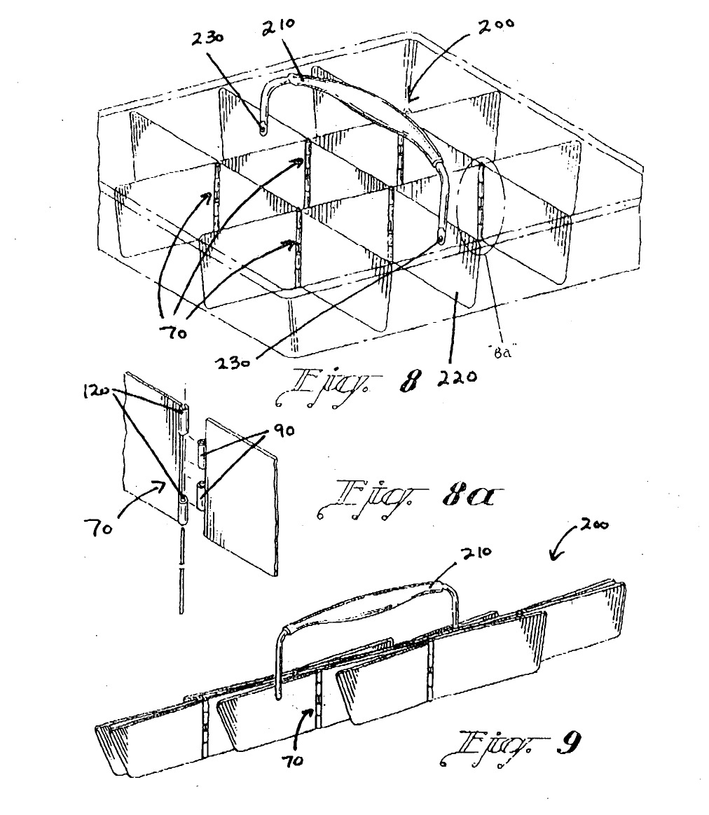

The lateral cutting blades 50 are sized and shaped to laterally section an entire food item 20 width within a baking pan 30 into a plurality of laterally sectioned smaller portions. Each of the lateral cutting blades 50 has two engaging hinge portions 90 spaced at a predetermined distance apart as show in FIGS. 1 and 4. The detail of a preferred embodiment of the hinges 70 having an engaging hinge portion 90 is shown in FIG. 8a. Each of the lateral cutting blades 50 has end portions 100 angled to compensate for the angularity of upright walls 110 of the baking pan 30 when the food bar cutter 10 is pressed into a food item 20 within the baking pan 30 as shown in FIG. 6.

The longitudinal cutting blades 60 are sized and shaped to longitudinally section an entire food item 20 length within a baking pan 30 into a plurality of longitudinally sectioned smaller portions. Each of the longitudinal cutting blades 60 have four retaining hinge portions 120 spaced to hingedly connect to the engaging hinge portions 90 of the lateral cutting blades 50 providing pivotal freedom of movement between the lateral cutting blades 50 and the longitudinal cutting blades 60. The detail of the retaining hinge portion 120 is shown in FIG. 8a. The engaging hinge portions 90 and retaining hinge portions 120 can be switched between the lateral cutting blades 50 and the longitudinal cutting blades 60 and still achieve the desired results of the claimed invention. Each longitudinal cutting blade has end portions 130 angled to compensate for angularity of upright walls 110 of the baking pan 30 when the food bar cutter 10 is pressed into a food item 20 within the baking pan 30 as shown in FIG. 6.

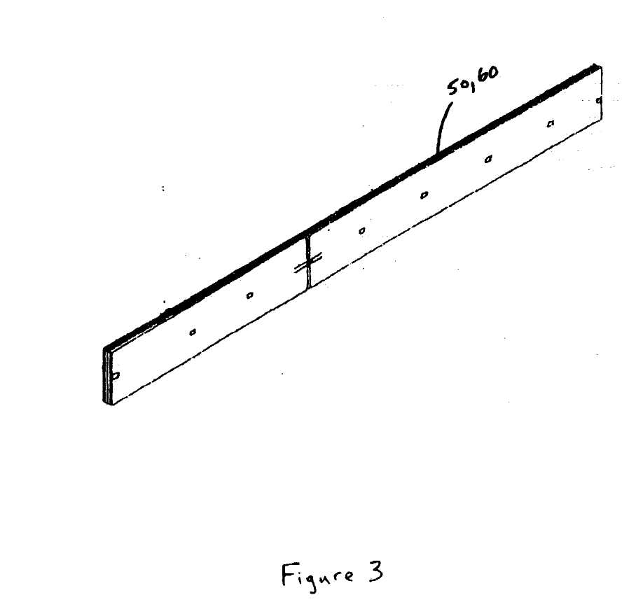

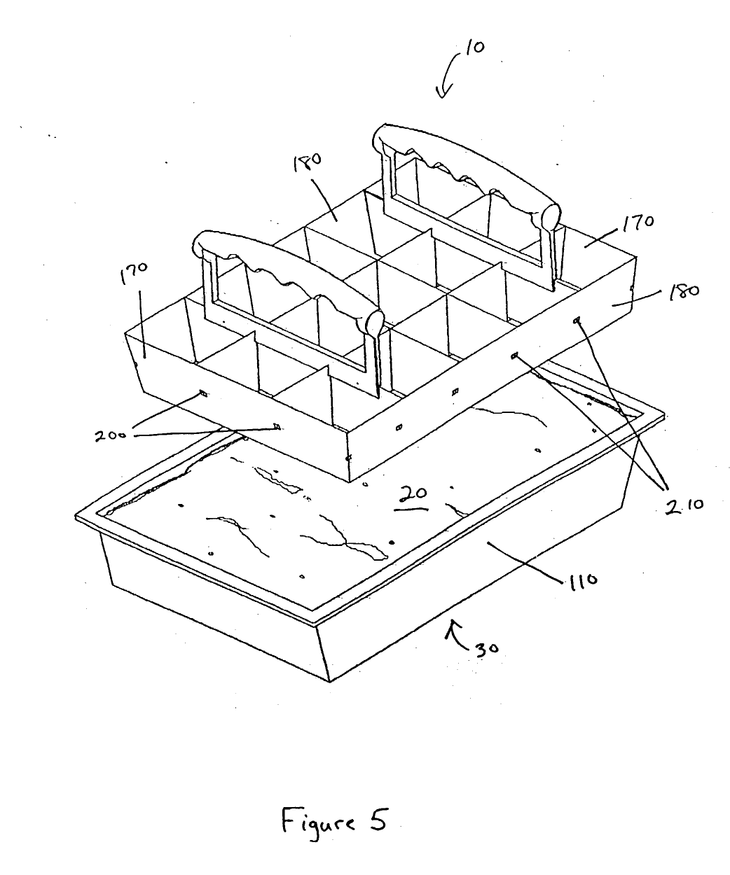

The handles 80 are shaped for applying manual force perpendicular to the lateral cutting blades 50 and longitudinal cutting blades 60 during use. Each handle 80 has a receiving channel 150 for receiving an edge 160 of the lateral blades as shown in FIG. 1. The handles 80 show in FIGS. 1-7 are removably connected to the blades 50, 60 so that the cutter 10 can be folded into a closed position as shown in FIG. 3 where the blades 50, 60 are in a substantially coplanar orientation to reduce space required for storage of the cutter 10. The handles 80 have a button 165 that can be depressed to release the handles 80 from the lateral cutting blades.

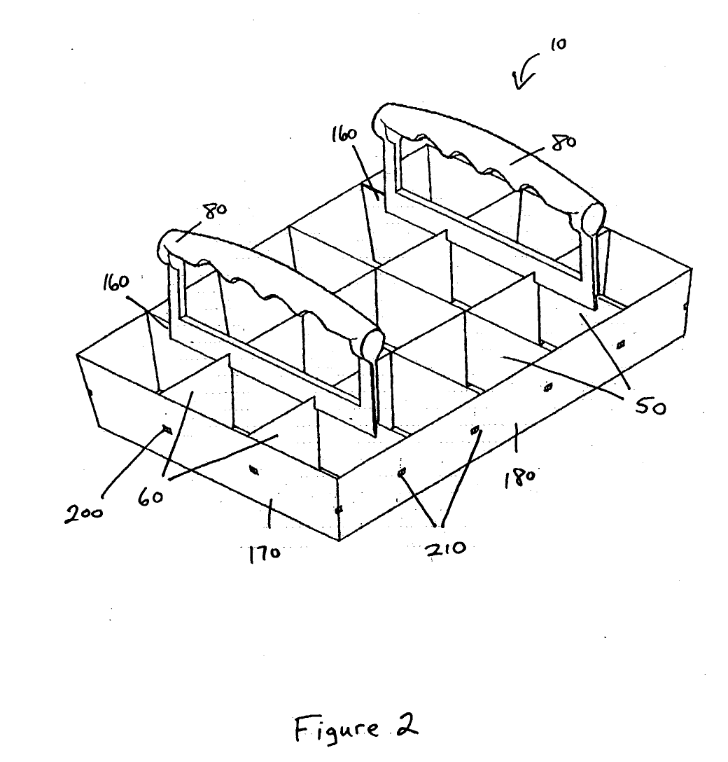

The food bar cutter 10 may also have edge blades 170, 180 as shown in FIG. 2 connected to the ends of the lateral cutting blades 50 and longitudinal cutting blades 60 for cutting off the edge of the food item 20 about the margin 190 of the food item 20 as shown in FIG. 7. Each lateral edge blade 170 has two receiving slots 210 for receiving the end portions 130 of the longitudinal cutting blades 60. Each longitudinal edge blade 180 has four receiving slots 210 for receiving the end portions 100 of the lateral cutting blades 50.

The food bar cutter 10 is configured for use in conjunction with a baking pan 30 which may have a size of 9 inches by 12 inches. However, the food bar cutter 10 of the claimed invention can be configured for use with baking pans of other sizes and shapes, such as 9 inches by 9 inches. During use, the lateral cutting blades 50 and the longitudinal cutting blades 60 coact to cut the food item 20 within the pan 30 into a plurality of smaller sections 40 or bars as shown in FIGS. 6 and 7.

FIG. 8 shows a preferred embodiment of my invention where the cutter 200 has a single centrally located handle 210. In this embodiment of the invention, the handle 210 is fastened to one side of the lateral cutting blade 220 by rivets 230 to allow the cutter 200 to be folded for storage into a substantially folded or compressed arrangement as shown in FIG. 9. It should be understood that it is within the scope of my invention to use different handle arrangements other than a single handle (see FIG. 1, as one example) which functions very well where the cutter 200 is used to cut brownies. Where pizzas are to be cut, where a larger food mass (or food bar) needs to be cut, a two handle arrangement (see FIG. 1) may be usable since the food product can then be more easily cut with two handles than with one handle. Two handles can be spaced apart and riveted to separate spaced apart cutting blades 22 in the same manner as illustrated in FIGS. 8 and 9.

Although the invention has been described by reference to some embodiments it is not intended that the novel device be limited thereby, but that modifications thereof are intended to be included as falling within the broad scope and spirit of the foregoing disclosure, the following claims and the appended drawings.

I claim:

1. A foldable cutter for sectioning an entire food item within a food preparation container into a plurality of equally sized smaller sections, the cutter comprising:
at least one lateral cutting blade for laterally sectioning an entire food item width within a food preparation container during use with at least one engaging hinge portion;
at least one longitudinal cutting blade for longitudinally sectioning an entire food item length within a food preparation container with at least one retaining hinge portion hingedly connected to the engaging hinge portion of the lateral cutting blade providing pivotal freedom of movement between the lateral cutting blade and the longitudinal cutting blade, the lateral cutting blade and the longitudinal cutting blade coacting to cut at least two sides of a food item section during use; and
at least one removable handle shaped for providing manual force perpendicular to the lateral cutting blade and longitudinal cutting blade during use.

2. The cutter of claim 1 further comprising:
a second engaging hinge portion within the lateral cutting blade laterally spaced from the engaging hinge portion of the lateral cutting blade;
a second longitudinal cutting blade for longitudinally sectioning an entire food item length within a food preparation container having a second retaining hinge portion hingedly connecting the second longitudinal cutting blade to the lateral cutting blade positioning the second longitudinal cutting blade parallel to the longitudinal cutting blade.

3. The cutter of claim 2 further comprising:
a third retaining hinge portion within the longitudinal cutting blade longitudinally spaced from the retaining hinge portion of the longitudinal cutting blade;
a fourth retaining hinge portion within the second longitudinal cutting blade longitudinally spaced from the second retaining hinge portion of the second longitudinal cutting blade;
a second lateral cutting blade for laterally sectioning an entire food item width within a food preparation container having a third engaging hinge portion hingedly connecting the second lateral cutting blade to the longitudinal cutting blade and a fourth engaging hinge portion laterally spaced from the third engaging hinge portion hingedly connecting the second lateral cutting blade to the second longitudinal cutting blade; and
a second removable handle shaped for providing manual force perpendicular to the second lateral cutting blade and the second longitudinal cutting blade during use.

4. The cutter of claim 1 wherein the lateral cutting blade has an end portion angled to compensate for angularity of upright walls of the food preparation container during use.

5. The cutter of claim 4 wherein the longitudinal cutting blade has an end portion angled to compensate for angularity of upright walls of the food preparation container during use.

6. The cutter of claim 4 wherein the handle has a receiving channel for receiving an edge of a blade.

7. The cutter of claim 3 further comprising at least one edge blade connected to an exterior end of the lateral cutting blade and an exterior end of the second lateral cutting blade cutting a fourth side of a food item section during use.

8. The cutter of claim 7 further comprising a second edge blade connected to an exterior end of the longitudinal cutting blade and an exterior end of the second longitudinal cutting blade.

9. A foldable cutter for sectioning an entire food item within a food preparation container into a plurality of equally smaller sections, the cutter comprising:
an orthogonally arranged lattice of cutting blades sized and shaped to fit within a food preparation container having an upright side, the cutting blades sectioning an entire food item within the food preparation container into a plurality of smaller sections;
a plurality of hinge connections hingedly connecting the cutting blades providing means for pivotally changing the relationship between the cutting blades from the orthogonal arrangement to a substantially coplanar arrangement;
at least one handle for providing manual force perpendicular to the cutting blades during use.

10. The cutter of claim 9 wherein the cutting blades have end portion angled to compensate for angularity of the upright side during use.

11. The cutter of claim 9 further comprising an edge blade connected to at least two end portions of the cutting blades for sectioning an edge of the food item contacting the upright side of the food preparation container from the plurality of smaller sections.

12. A method of sectioning an entire food item within a food preparation container with a foldable cutter, the method comprising:
changing the arrangement of a plurality of substantially unidirectional cutting blades to an orthogonal arrangement;
moving the orthogonal arrangement of cutting blades over a food item within a food preparation container having edges defined by upright walls of the food preparation container;
orienting the orthogonal arrangement of cutting blades to fit within the upright walls of the food preparation container when pressed into the food item;
applying force perpendicular to the orthogonal arrangement of cutting blades simultaneously orthogonally sectioning an entire food item into a plurality of smaller sections with the cutting blades; and
removing the orthogonal arrangement of cutting blades from the food item sections.

13. A foldable cutter for sectioning an entire food item within a food preparation container into a plurality of equally smaller sections, the cutter comprising:
an orthogonally arranged lattice of cutting blades sized and shaped to fit within a food preparation container having an upright side, the cutting blades sectioning an entire food item within the food preparation container into a plurality of smaller sections;
a plurality of hinge connections hingedly connecting the cutting blades providing means for pivotally changing the relationship between the cutting blades from the orthogonal arrangement to a substantially coplanar arrangement; and
manually operable means connected to the cutter for providing manual force to the cutting blades during use when the lattice is folded into a substantially orthogonal arrangement.

14. The cutter of claim 13 wherein the cutting blades have an end portion to compensate for angularity of the upright side during use.

15. The cutter of claim 14 further comprising an edge blade connected to at least two end portions of the cutting blades for sectioning an edge of the food item contacting the upright side of the food preparation container from the plurality of smaller sections.

16. The cutter of claim 15 wherein said manually operable means comprises a handle riveted to one of the blades for providing manual force to the cutting blades during use when the lattice is folded into a substantially orthogonal arrangement.

17. The cutter of claim 13 wherein said cutter is foldable into a compressed flat form when the blades are folded at said hinge connections.

18. A foldable cutter for sectioning an entire food item within a food preparation container into a plurality of equally smaller sections, the cutter comprising:
criss-cross arranged cutting blades sized and shaped to fit within a food preparation container having an upright side, the cutting blades sectioning an entire food item with the food preparation container into a plurality of smaller sections;
piano hinge type connections hingedly connecting the cutting blades, said piano hinge type connections providing means for pivotally changing the relationship between the cutting blades from the criss-cross arrangement to a substantially coplanar arrangement for storage; and
handle means connected to the cutter for providing manual force to the cutting blades during use.

19. The cutter of claim 18 wherein said cutter is collapsible into a compressed flat form when the blades are manually folded at said hinge connections.

20. The cutter of claim 18 wherein said handle means comprises a handle riveted to only one of the blades.
